(19) United States
(12) Patent Application Publication
(10) Pub. No.: US 2018/0144642 A1
(43) Pub. Date: May 24, 2018

(54) SYSTEM AND METHOD FOR INTELLIGENT AND SECURE STORAGE UNIT

(71) Applicant: Wal-Mart Stores, Inc., Bentonville, AR (US)

(72) Inventors: Donald R. High, Noel, MO (US); John J. O'Brien, Farmington, AR (US)

(21) Appl. No.: 15/814,209

(22) Filed: Nov. 15, 2017

Related U.S. Application Data
(60) Provisional application No. 62/425,147, filed on Nov. 22, 2016.

(51) Int. Cl. G08G 5/00; H04W 12/06; B64C 39/02; G06Q 10/08; G06Q 50/28

(52) U.S. Cl. CPC G08G 5/0013; H04W 12/06; B64C 39/024; B64C 2201/128; G06Q 10/083; G06Q 50/28; B64C 2201/146; G08G 5/0069

(57) ABSTRACT

An intelligent and secure storage unit includes a plurality of storage compartments, an environmental control apparatus, a transceiver, and a control circuit. The environmental control apparatus is configured to individually control environmental conditions in each of the plurality of storage compartments. The control circuit assigns individual compartments according to an identity of the courier using the compartment, and whether the compartment will receive a package from a courier or return a package to the courier. The unmanned autonomous vehicle deposits a package, the control circuit obtains environmental information concerning environmental conditions required by the package, and adjusts the environmental control apparatus of the selected compartment to provide the environmental conditions required by the package.

### CROSS-REFERENCE TO RELATED APPLICATION

This application claims the benefit of the following U.S. Provisional Application No. 62/425,147 filed Nov. 22, 2016, which is incorporated herein by reference in its entirety.

### TECHNICAL FIELD

This invention relates generally to storage units, and more particularly, to intelligent and secure storage units that may be used by autonomous vehicles to deposit and retrieve packages.

### BACKGROUND

The security of packages has been an issue when delivering packages to the home or business of a customer. Security is especially a concern in the “last mile” in the delivery path, that is, the portion of the delivery path that is at or in very close proximity to the destination. For example, a customer will order a product, courier services will place the package on the doorstep of a customer's home, and the product is stolen by another person.

Another problem in package delivery concerns damage caused to the package by environmental conditions or by not meeting certain storage conditions once the package is delivered. For instance, rain (or other adverse conditions) may damage a package. In another example, a frozen package of food may spoil if not retained at an adequate temperature at the delivery site.

Additionally, tracking and monitoring products in the final phase of the delivery is difficult to achieve with standard packaging. The retailer has very little insight into who received the package, who delivered the package, when the package was delivered, when the package was removed, and/or what is the status of the package as it awaits removal.

Autonomous vehicles (e.g., aerial drones) are emerging as solutions for delivery, especially for the last mile. Unfortunately, there is very little navigational guidance for these autonomous vehicles as they traverse the last mile to the customer. Given this uncertainty, packages might be delivered far from the intended target location (e.g., on the sidewalk and not at the door). Dropping a package within a general vicinity of the target location is not acceptable when we are deploying such systems.

Further, when autonomous vehicle systems are completing delivery at the residence or business of a customer, there are additional concerns over the safety of patrons as well as the autonomous vehicle itself. For example, completing a delivery to a customer's doorstep, the drone may strike a customer or some other object.

Current approaches have proved inadequate in addressing these problems. Consequently, there is some customer dissatisfaction with current systems.

### BRIEF DESCRIPTION OF THE DRAWINGS

Disclosed herein are embodiments of systems, apparatuses and methods pertaining to providing and operating an intelligent and secure storage unit. This description includes drawings, wherein:

FIG. 1 is a block diagram of an intelligent and secure storage unit in accordance with some embodiments;

FIG. 2 is a block diagram of an intelligent and secure storage unit in communication with various vehicles in accordance with some embodiments;

FIG. 3 is a block diagram of an intelligent and secure storage unit and an authentication process with a drone in accordance with some embodiments;

FIG. 4 is a flowchart of an authentication process between a drone and an intelligent and secure storage unit in accordance with some embodiments;

FIGS. 5A-5F are diagrams showing a delivery sequence between a drone with an intelligent and secure storage unit in accordance with some embodiments;

FIG. 6 is a drawing of a drone, and an intelligent and secure storage unit showing video images at both in accordance with some embodiments;

FIG. 7 is a drawing of a drone, and an intelligent and secure storage unit showing video images at both in accordance with some embodiments;

FIG. 8 is a drawing of an intelligent and secure storage unit as a human places a package in the unit in accordance with some embodiments;

FIG. 9 is a flowchart showing an example of a process for a human to return a package to a courier in accordance with some embodiments;

FIG. 10 is a flowchart showing a further example of a process used to return a package to a courier in accordance with some embodiments;

FIG. 11 is a flowchart showing a further example of a process for returning a package to a courier in accordance with some embodiments;

FIG. 12 is a block diagram of an intelligent and secure storage unit that controls environmental conditions within the unit in accordance with some embodiments;

FIG. 13 is a flowchart of an approach for using an intelligent and secure storage unit to control environmental conditions in accordance with some embodiments;

FIG. 14 is a block diagram showing a storage unit with multiple compartments within the unit in accordance with some embodiments;

FIG. 15 is a flowchart of an approach for an intelligent and secure storage unit to control environmental conditions in accordance with some embodiments;

FIG. 16 is a cutaway view of an intelligent and secure storage unit showing internal mechanical devices that facilitate the movement of packages within the unit in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for intelligent and secure storage units that facilitate the reception, storage, and return of packages. Packages are provided with the security, monitoring, tracking (e.g., who delivered the package, when the package was delivered, when the package was removed, and the status of a package), environment management, and navigational guidance needed to complete the final phase in the “last mile” of package delivery. Navigational guidance (and/or control) can be provided for autonomous vehicles (e.g., aerial drones or ground vehicles) or traditional courier services (e.g., the U.S. Post Office, or commercial package delivery services).

Subscription services for the autonomous and fast delivery of packages may also be provided. For example, monthly subscriptions to the intelligent and secure storage units described herein may be provided. In one example, the cost of the service may be offset after a certain number of packages have been ordered through the service. In another example, a deposit is required for a subscription. This deposit may be refunded after a certain number of packages have been ordered through the service. Other examples of subscription-based services are possible.

The intelligent and secure storage can be disposed at various locations at homes and businesses. For example, retailers may place the unit at strategic, high-impact, zones or locations. Retailers may also place the devices at special, convenient locations for loyal customers who purchase often.

Navigational guidance and control of vehicles depositing or retrieving packages can originate at a number of locations. For example, and in the example of an aerial drone, flight control can be disposed on-board the drone, at another ground control system, or at the storage unit. If control resides at the unit, the unit can take control of any compatible apparatus on the drone for more accurate positioning of the drone, thereby ensuring a safe approach to the unit.

More sensing equipment can be on the box than the drone without interfering with payload weight. In one example, LIDAR can be used from the unit up to the drone, or from the drone down to the unit for 3D positioning. Other approaches such as reading barcodes, beacons, or lasers can also be used to provide accuracy in landing or guiding the drone.

In some aspects, the unit may control the operation of the drone. For example, sensors at the unit may determine the position of the drone. Once this position is determined, the unit may control the operation of the drone after the drone comes within a predetermined distance of the unit.

The unit can also have various capture systems for package delivery. In one example, a drone may simply set a package down into the storage unit. In another example, a net may be used to catch the package when dropped by the drone. With a net in the box, the package can be safely dropped without damage. In still another example, a funnel type catching basket may also be used so that the dropping of the package from the drone does not have to be as accurate. The unit could also be mobile (e.g., a robot). In this case, the mobile unit could retrieve the package at a safe distance in a controlled area and then deliver the package to the house.

In some embodiments, an intelligent and secure storage unit receives and stores packages from couriers and facilitates the return of packages to the couriers. The unit includes a plurality of storage compartments, one or more position determination sensors, an environmental control apparatus, a transceiver, and a control circuit. The environmental control apparatus is configured to individually control environmental conditions in each of the plurality of storage compartments. The control circuit is coupled to the transceiver, the one or more position determination sensors, and the environmental control apparatus.

The position determination sensors are configured to obtain location information concerning the position of an unmanned autonomous vehicle. The unmanned autonomous vehicle guides, controls, or navigates itself when disposed beyond a predetermined distance from the intelligent and secure storage unit. The control circuit guides, controls, or navigates the unmanned autonomous vehicle within the predetermined distance of the intelligent and secure storage unit via communications transmitted from the transceiver according to the location information obtained by the position determination sensors.

The control circuit assigns individual compartments according to an identity of the courier using the compartment, and whether the compartment will receive a package from a courier or return a package to the courier. The unmanned autonomous vehicle deposits a package, the control circuit obtains environmental information concerning environmental conditions required by the package, and adjusts the environmental control apparatus of the selected compartment to provide the environmental conditions required by the package.

In aspects, the control circuit authenticates the identity of an unmanned autonomous vehicle, and grants permission for the unmanned autonomous vehicle to access the intelligent and secure storage unit.

In other examples, the unmanned autonomous vehicle is an aerial drone or a ground vehicle. In other examples, the intelligent and secure storage unit includes a scanner that scans packages for the environmental information, and the control circuit is configured to analyze the scanned environmental information to determine the environmental conditions required by the package. In other aspects, the intelligent and secure storage unit includes a user interface that is configured to receive authentication information from a human requesting that a human be allowed to access the intelligent and secure storage unit.

In some examples, the intelligent and secure storage unit communicates with devices inside a residence via the transceiver. In other aspects, the intelligent and secure storage unit communicates with the couriers via the transceiver. In other examples, the intelligent and secure storage unit communicates with smart devices via the transceiver. In yet other examples, the control circuit tracks packages received at and removed from the intelligent and secure storage unit. In other examples, an exterior control center (e.g., at the courier) tracks the packages.

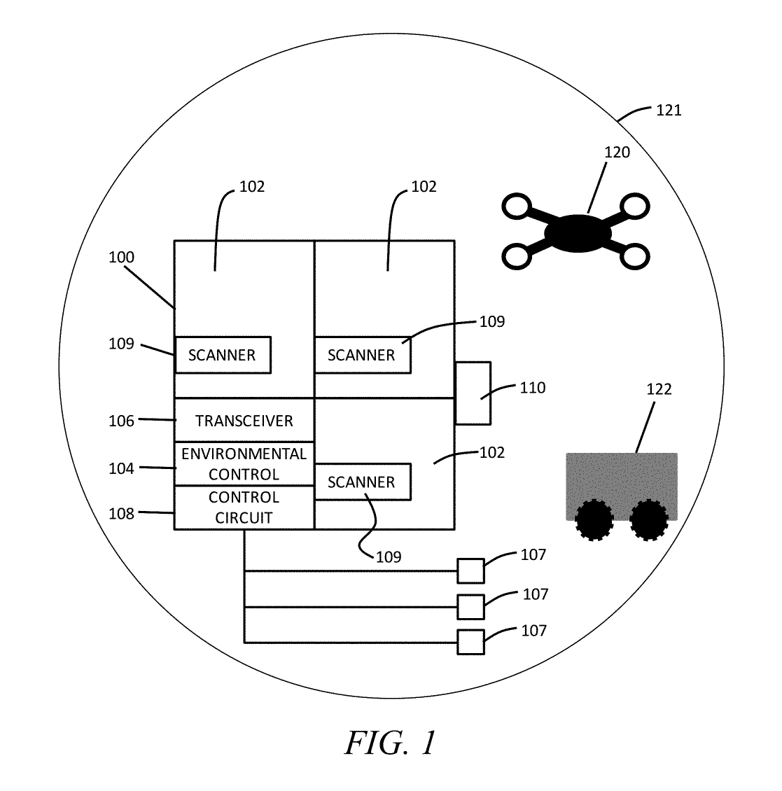

Referring now to FIG. 1, one system that utilizes an intelligent and secure storage unit 100 that receives and stores packages from couriers and facilitates the return of packages to the couriers is described. The unit 100 includes a plurality of storage compartments 102, an environmental control apparatus 104, a transceiver 106, a control circuit 108, and an interface 110. In one example, the unit 100 is situated on the porch of a home. In another example, the unit 100 is disposed at the door of a business.

Storage compartments 102 are arranged in the unit 100. These compartments can take on a wide variety of sizes and/or shapes. In another aspect, the sizes (volumes) and/or shapes can be manually or automatically adjusted. For example, partitions separating the compartments may be adjusted to alter the size and/or shape of these compartments.

Each of the storage units 102 has a door that opens to the exterior environment and allows selected humans, drones, or unmanned ground vehicles to access each of the units 102. Additionally, individual ones of the units 102 may have conveyor belts, lifts, or other mechanical devices that move contents into, out of, and/or with each of the compartments 102.

The environmental control apparatus 104 is configured to individually control environmental conditions in each of the plurality of storage compartments. For example, the environmental control apparatus 104 may separately control the temperature in each unit. In aspects, each unit may have heating coils and/or cooling units that can be activated and deactivated as needed to alter the temperature in each of the compartments 102. A thermometer or other type of sensor may be deployed in each of the compartments 102 to monitor the temperature of a particular compartment. It will be appreciated that in the examples described herein, temperature of chambers is monitored and controlled. Other conditions (e.g., pressure and amount of light to mention two examples) may also be monitored and controlled.

The transceiver 106 transmits and receives communications from unmanned autonomous vehicles. For example, communications may be exchanged with an aerial drone 120 and an unmanned autonomous ground vehicle 122. In aspects, these communications are used to authenticate the identity of the drone (or unmanned autonomous vehicle), and/or guide (or control) the drone (or unmanned autonomous vehicle) to and from the unit 100. The transceiver 106 may also communicate wirelessly with other computer or communication networks such as the WiFi network of the home in which the unit 100 is deployed.

The term control circuit refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 108 may be configured (for example, by using corresponding programming stored in a memory as will be well understood by those skilled in the art) to carry out one or more of the steps, actions, and/or functions described herein.

The control circuit 108 is coupled to the transceiver and the environmental control apparatus. The control circuit 108 is configured to communicate with the drone 120 or unmanned autonomous ground vehicle 122 via the transceiver 106, and direct and navigate the drone 120 or unmanned autonomous ground vehicle 122 to and from the intelligent and secure storage unit 100.

A scanner 109 in each of the compartments is configured to scan packages (e.g., the labels on packages) as they enter and/or leave the compartment. When entering the compartment 102, the scanned information can be used to determine the environmental conditions needed by the package. For instance, if the package is frozen food, then the control circuit 108 controls the environmental control apparatus 104 to change the temperature in the compartment so as to preserve the contents of the package based upon the scanned information.

The interface 110 may include a graphical display unit. A human may enter information to access any of the compartments 102. For instance, a human may enter an access code or password to open or access one or more of the compartments 102.

Location determination sensors 107 are coupled to the control circuit 108. The coupling may be a wired coupling, a wireless coupling, or a combination of wireless and wired couplings. The sensors 107 may be disposed at (e.g., on top, or attached to the side) of the unit 107. In other examples, some or all of the sensors 107 may be disposed at other locations away from the unit 100 (e.g., at base stations disposed about a warehouse). Any number of sensors 107 can be utilized.

The location determination sensors 107 obtain information concerning the position of aerial drone 120 and/or autonomous ground vehicle 122. The sensed information relates to the position or location of the aerial drone 120 and/or autonomous ground vehicle 122. In examples, the sensors 107 may be cameras, lasers, beacons, scanners, transmitters, receivers, or any combination of these or other sensing devices. The sensors 107 may receive and/or transmit any type of signal. In one particular example, LIDAR approaches (known to those skilled in the art) are used by the control circuit 108 and sensors 107 to determine the position of the aerial drone 120 and/or the autonomous ground vehicle 122. Time of arrival and triangulation approaches (known to those skilled in the art) may also be used by the control circuit 108 to determine the position of the aerial drone 120 and/or autonomous ground vehicle 122 from sensed information obtained by the sensors 107. The location or position of the vehicles 120, 122 may be absolute geographic coordinates or relative geographic coordinates.

The transceiver 106 can be used to communicate messages from the control circuit 108 to the aerial drone 120 and/or the autonomous ground vehicle 122. These messages may guide or instruct the aerial drone 120 and/or the autonomous ground vehicle 122. For example, the messages may include the position of the drone and instructions to move a certain distance in a particular direction. Alternatively, the messages may affirmatively control the movement of the aerial drone 120 and/or the autonomous ground vehicle 122. For example, the messages may cause the aerial drone 120 and/or the autonomous ground vehicle 122 to move in a certain direction, at a certain speed, to a certain location.

In other aspects, the wherein the aerial drone 120 and/or the autonomous ground vehicle 122 guide themselves when beyond a predetermined distance 121 (e.g., one-half a mile) from the intelligent and secure storage unit 100. The control circuit 108 then guides the aerial drone 120 and/or the autonomous ground vehicle 122 within this predetermined distance 121 via communications transmitted from the transceiver 106 according to the location information obtained by the sensors 107. Guidance may include advising the aerial drone 120 and/or the autonomous ground vehicle 122 of its position and/or possible course corrections. Additionally, guidance may include actual control of the aerial drone 120 and/or the autonomous ground vehicle 122 via messages transmitted from the transceiver circuit 106.

Effectively, a control hand-off is performed from the aerial drone 120 and/or the autonomous ground vehicle 122 to the control circuit as the aerial drone 120 and/or the autonomous ground vehicle 122 comes within the predetermined distance 121 of the unit 100. In one particular example, GPS approaches are used to guide the aerial drone 120 and/or the autonomous ground vehicle 122 to a location outside the predetermined distance 121, while the control circuit 108 (through messages transmitted via the transceiver 106) controls operation when vehicles 120, 122 are at a location within the predetermined distance 121. It will be understood that all these examples are described with respect to an unmanned vehicle approaching the unit 100, that they are equally applicable in the opposite direction when the unmanned vehicle moves from within the predetermined to outside the predetermined distance 121. That is, control passes again to the unmanned vehicle when the unmanned vehicle passes outside the predetermined distance 121.

It will be appreciated that the predetermined distance 121 may be a uniform distance surrounding the unit 100 (e.g., a circle of predetermined radius). However, in other approaches, the predetermined distance 121 may vary about the unit 100 (e.g., the distance may be greater above the unit 100, but less in front and behind the unit 100).

In other examples of the operation of the system of FIG. 1, the control circuit 108 assigns individual ones of the compartments 102 according to an identity of the courier using the compartment, and whether the compartment will receive a package from a courier or return a package to the courier. When an unmanned autonomous vehicle (aerial drone 120 or autonomous ground vehicle 122) deposits a package, the control circuit 108 obtains environmental information concerning environmental conditions required by the package via the scanner 109, and adjusts the environmental control apparatus 104 of the selected compartment 108 to provide the environmental conditions required by the package.

It will be appreciated that individual ones of the compartments 102 are configured on-the-fly and in real time to meet the needs of users and packages that are being delivered or returned. To take one example and at a first time, a compartment may maintain a first temperature within the compartment to suit the needs of a first package, while at a second time, a second temperature is maintained to suit the needs of a second package. In other words, conditions or dimensions within individual ones of the compartments 102 are not frozen in time and can be adjusted as needed. This provides great flexibility in the use of the storage unit 100.

The unit 100 may also be operated in a large number of ways. For instance, subscription services (e.g., monthly) for the autonomous and fast delivery of packages may also be provided.

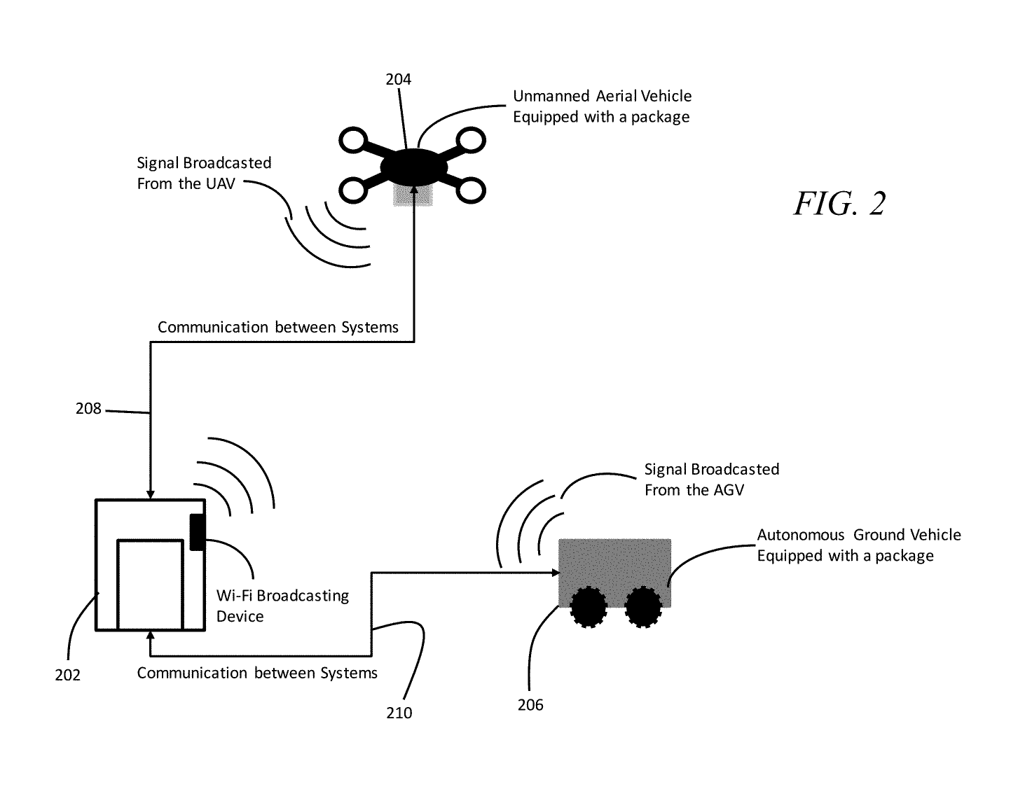

Referring now to FIG. 2, one example of an intelligent and secure storage unit 202 that is in communication with various autonomous vehicles is described. The intelligent and secure storage unit 202 exchanges communication with an autonomous aerial drone 204 and an autonomous ground vehicle 206. First communications 208 are exchanged between the intelligent and secure storage unit 202 and the autonomous aerial drone 204. Second communications 210 are exchanged between the intelligent and secure storage unit 202 and the autonomous ground vehicle 206.

The first communications 208 and the second communications 210 may implement or help implement a wide variety of functions. For example, the communications 208 and 210 may authenticate the identity of the drone 204 and ground vehicle 206 to the intelligent and secure storage unit 202. Additionally, the communications 208 and 210 may authenticate the identity of the intelligent and secure storage unit 202 to the drone 204 and the ground vehicle 206. Further, the communications 208 and 210 may guide the drone 204 to and from the intelligent and secure storage unit 202, and guide the ground vehicle 206 to and from the intelligent and secure storage unit 202.

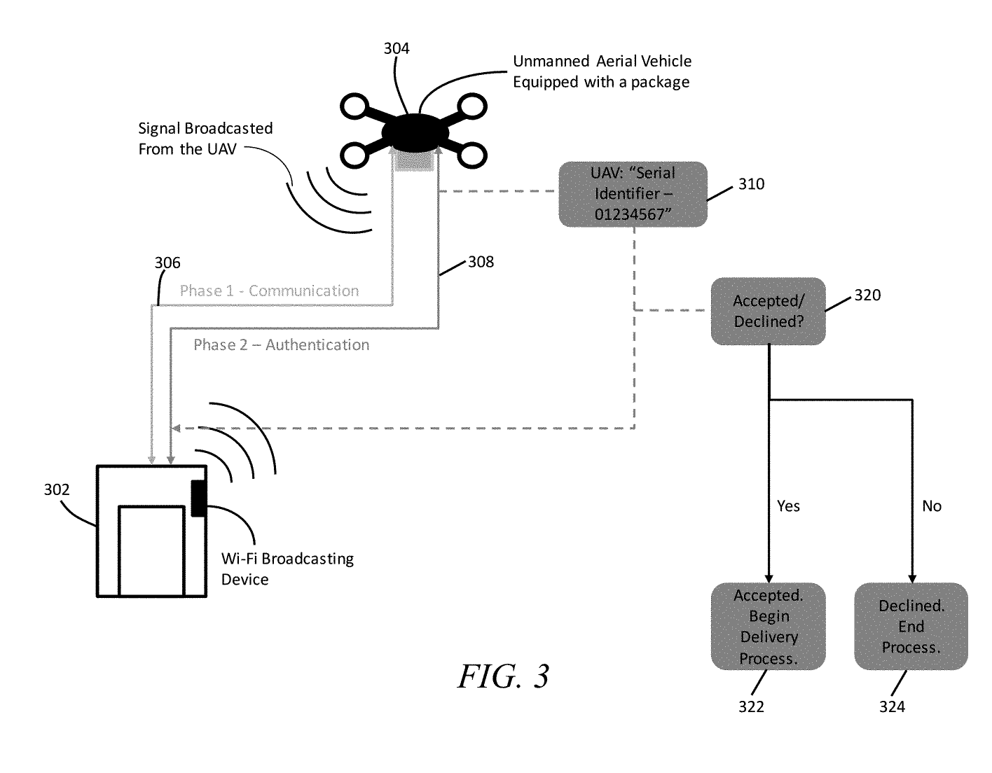

Referring now to FIG. 3, one example of an authentication process between an intelligent and secure storage unit 302 and a drone 304 is described. In a first phase, communications 306 are exchanged between the intelligent and secure storage unit 302 and the autonomous aerial drone 304. The communications 306 may be effective to establish a communication link between the intelligent and secure storage unit 302 and the autonomous aerial drone 304.

Authentication communications 308 are then exchanged between the intelligent and secure storage unit 302 and the autonomous aerial drone 304. For example, an unmanned aerial vehicle identifier 310 may be sent from the drone 304 to the intelligent and secure storage unit 302. At the intelligent and secure storage unit 302, authentication of the identifiers 310 and 312 are performed at step 320. For example, the received identifier may be compared to a list of acceptable and verified identifiers. If there is a match, the identifier is authenticated, and if there is no match, the identifier is not authenticated.

If the identifier is accepted, then at step 322, the delivery process proceeds. If the identifier is not accepted, at step 324 the process is ended. In other examples, the intelligent and secure storage unit 302 may send an identifier to the drone 304, and the drone 304 may perform an authentication process similar to the process performed at the intelligent and secure storage unit 302. Authentication allows the delivery process to proceed.

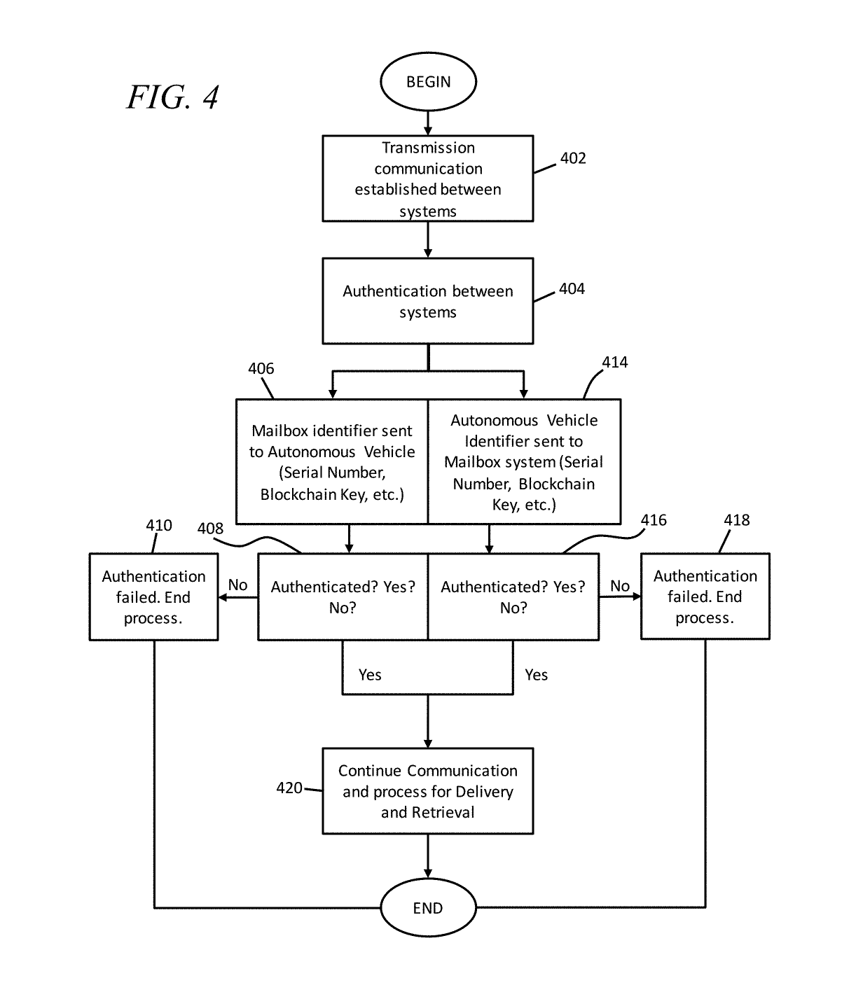

Referring now to FIG. 4, one example of an authentication process between a drone and an intelligent and secure storage unit is described. At step 402, a communication link is established between the drone and the intelligent and secure storage unit. At step 404, authentication begins between the drone and the intelligent and secure storage unit by executing two paths. A first path includes steps 406, 408, 410 and 420. A second path includes steps 414, 416, 418, and 420.

In the first path, at step 406 an identifier from the intelligent and secure storage unit is sent to the drone. The identifier may include (in examples) a serial number, a blockchain key, or other identification or verification information. At step 408, authentication of the identifier is performed. For example, the received identifier may be compared to a list of acceptable and verified identifiers. If the answer is negative, at step 410 authentication fails and the process ends. If the answer is affirmative, at step 412, the communication process continues (e.g., the communication path may be used to guide the drone to and from the intelligent and secure storage unit) and the delivery process proceeds.

In the second path and at step 414, an identifier is sent from the drone to the intelligent and secure storage unit. The identifier may include (in examples) a serial number, a blockchain key, or other information. At step 416, authentication of the identifier is performed. For example, the received identifier may be compared to a list of acceptable and verified identifiers. If the answer is negative, at step 418, authentication fails and the process ends. If the answer is affirmative, at step 412, the communication process continues (e.g., the communication path may be used to guide the drone to and from the intelligent and secure storage unit) and the delivery process proceeds.

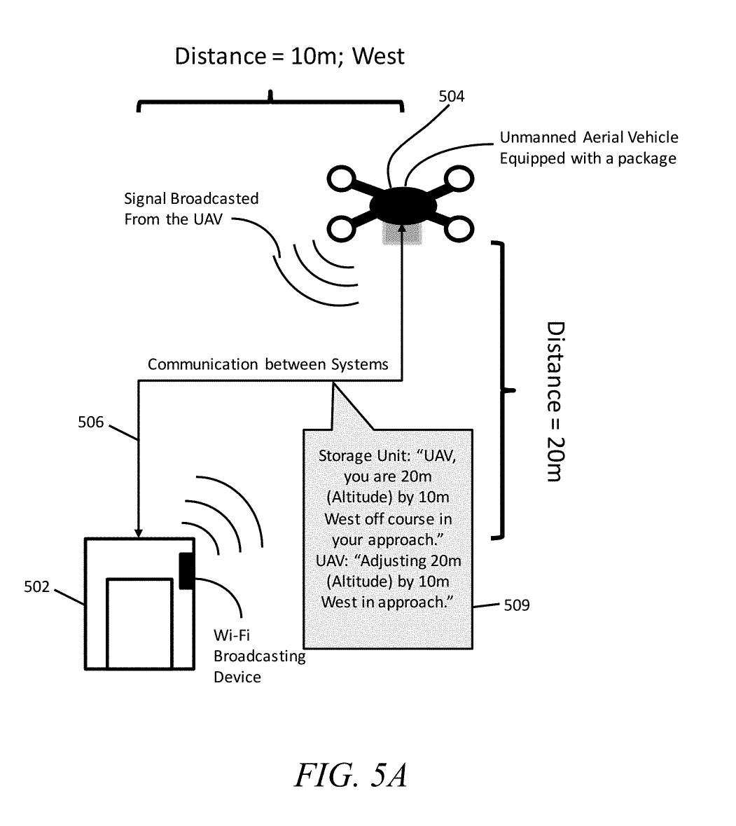

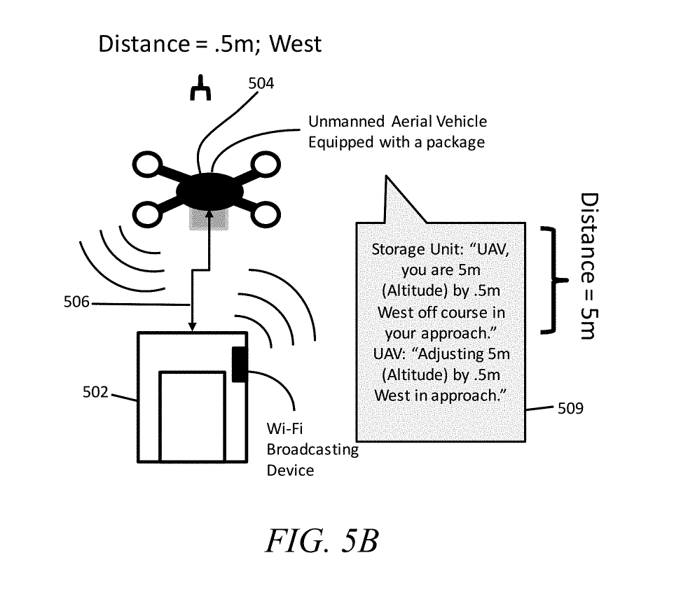

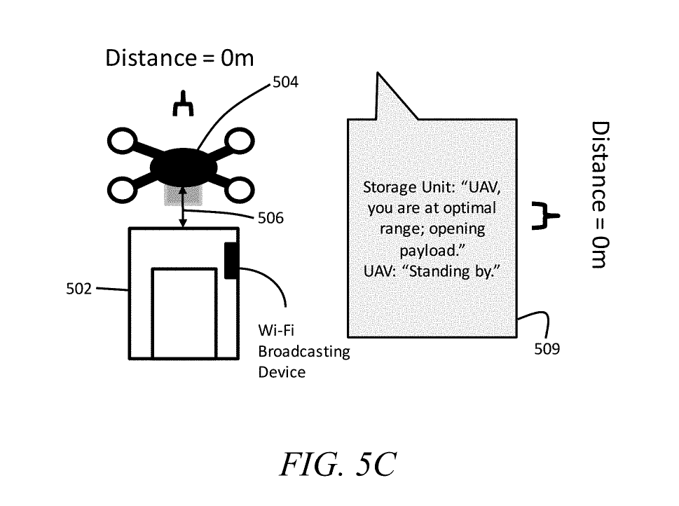

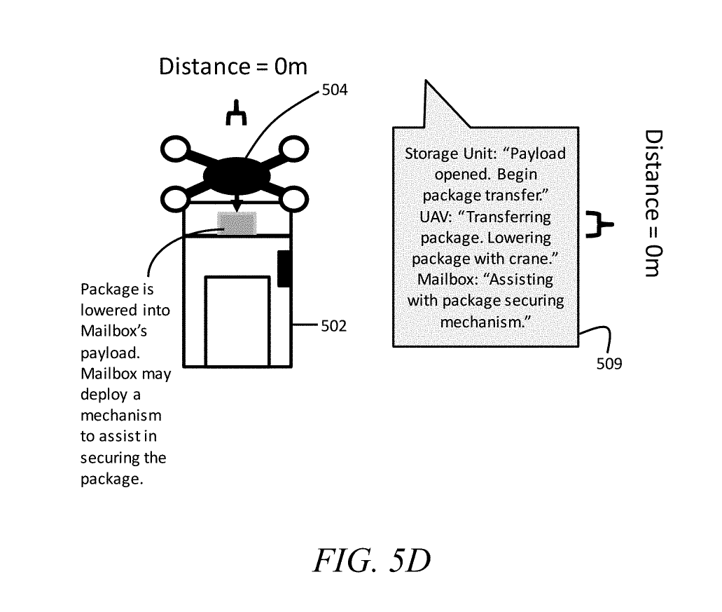

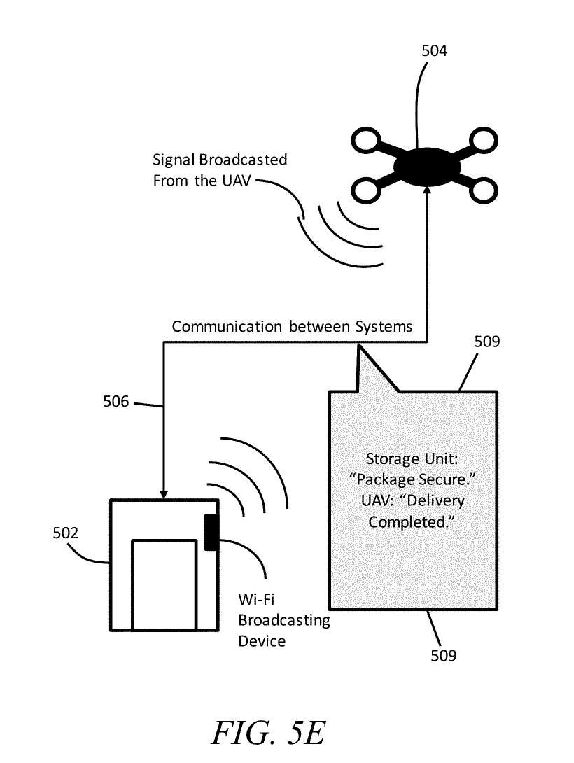

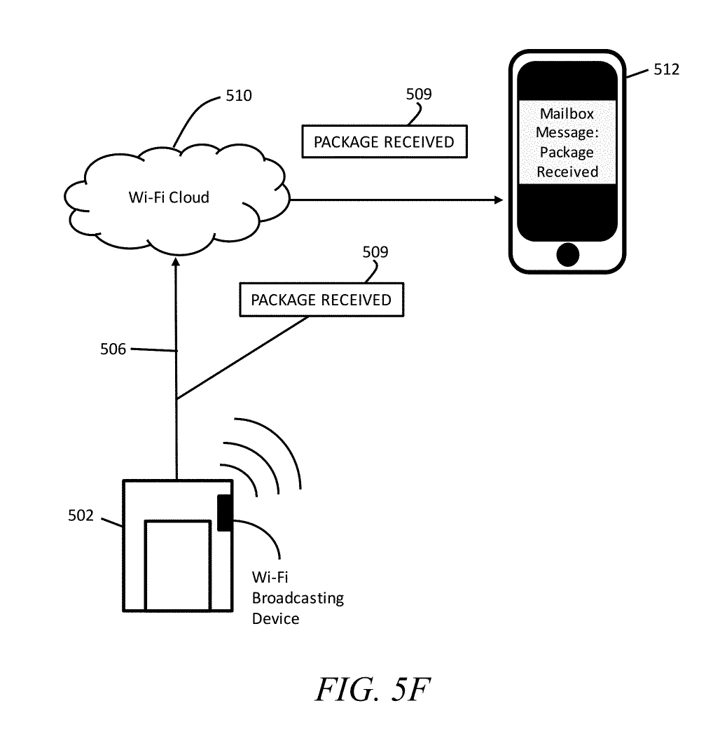

Referring now to FIGS. 5A-5F, one example of a navigation sequence between an unmanned aerial vehicle (UAV)(drone) 504 with an intelligent and secure storage unit 502 is described. A communication link 506 acts as a conduit or path to exchange messages (or information) between the two devices. In one example, the link 506 is wireless. The drawings show the sequence of the drone 504 depositing a package at the intelligent and secure storage unit 502. These approaches are also applicable to other autonomous vehicles such as autonomous ground vehicles.

The example sequence shown in FIGS. 5A-5F includes six phases. In a first phase, the drone 504 (or other autonomous vehicle) sends information to the storage unit 502. This information may include wind speed, altitude, and airframe speed, to mention a few examples. Video feeds from the autonomous vehicle may also be distributed to the storage unit 502. The drone 504 also communicates information concerning its location.

The storage unit 502 communicates information to the drone concerning wind speed, location information, and distance between the systems. Video feeds from the storage unit 502 may also be distributed to the drone.

In a second phase, the drone 504 (or other autonomous vehicle) communicates information concerning its location and position information in real-time with continuous updates to unit 502. The drone 504 may send information such as wind speed, altitude, airframe speed, and the distance and position between the two systems. Video feeds from the drone 504 may also be distributed to the storage unit 502.

The storage unit 502 communicates information on its location in real-time with continuous updates to the drone 504. Information may include wind speed, location information, and distance between the systems. Video feeds from the storage unit 502 may also be distributed to the drone 504.

In a third phase, the storage unit 502 assists the drone 504 (or other autonomous vehicle) with navigation to the unit 502. The drone 504 may send information such as changes for wind speed, altitude, airframe speed, and distance and position between the two systems. This process is ongoing until the delivery or retrieval of a payload (e.g., a package) is completed.

In a fourth phase, the package is transferred between the drone 504 and the storage unit 502. In a fifth phase, the drone 504 leaves the storage unit 502. In a sixth phase, other devices may obtain information about the transfer.

Turning now to FIG. 5A (phase 1), the drone 504 is 10 m west of the intelligent and secure storage unit 502. A message 509 from the intelligent and secure storage unit 502 to the drone 504 indicates to the drone 504 that the drone 504 is 20 m in height and 10 m too far west off course. A message 509 sent from the drone 504 to the intelligent and secure storage unit 502 indicates that the drone 504 is adjusting its altitude and course.

In FIG. 5B (phase 2), the drone 504 is 0.5 m west of the intelligent and secure storage unit 502. A message 509 from the intelligent and secure storage unit 502 to the drone 504 indicates to the drone 504 that the drone 504 is at 5 m in height and 0.5 m too far west off course. A message 509 sent from the drone 504 to the intelligent and secure storage unit 502 indicates that the drone 504 is adjusting its altitude and course.

In FIG. 5C (phase 3), the drone 504 is Om from the intelligent and secure storage unit 502. That is, the drone 504 is now at the unit 502. A message 509 sent from the intelligent and secure storage unit 502 to the drone 504 that indicates to the UAV 504 that it is at an optimal range for package delivery. A message 509 from drone 504 to the intelligent and secure storage unit 502 indicates that the drone 504 is standing by for further action.

At FIG. 5D (phase 4), the drone 504 is Om the intelligent and secure storage unit 502. A message 509 is sent from the intelligent and secure storage unit 502 to the drone 504 that indicates that the door of the unit 502 (where the package will be stored, or in the case of a retrieval, where the package is located) is open. A further message 509 sent from the drone 504 to the intelligent and secure storage unit 502 indicating that the drone 504 is transferring the package. Another message is sent from the storage unit 502 to the drone 502 indicating that the unit 502 is assisting with the delivery.

At FIG. 5E (phase 5), the drone is flying away from the intelligent and secure storage unit 502. A message 509 is sent from the intelligent and secure storage unit 502 to the drone 504 that indicates that the package is secure. Another message 509 is sent from the drone 504 to the unit 502 indicating that delivery is complete.

At FIG. 5F (phase 6), the intelligent and secure storage unit 502 communicates with a WiFi cloud (or other network) 510. The intelligent and secure storage unit 502 sends a message 509 to the cloud 509 reporting that the package has been received. The message 509 may be stored at the cloud. A smart device 512 (e.g., a smart phone) of a user communicates with the cloud 510 and can obtain or retrieve the message 509. Thus, a user can conveniently and quickly obtain information concerning the delivery of a package.

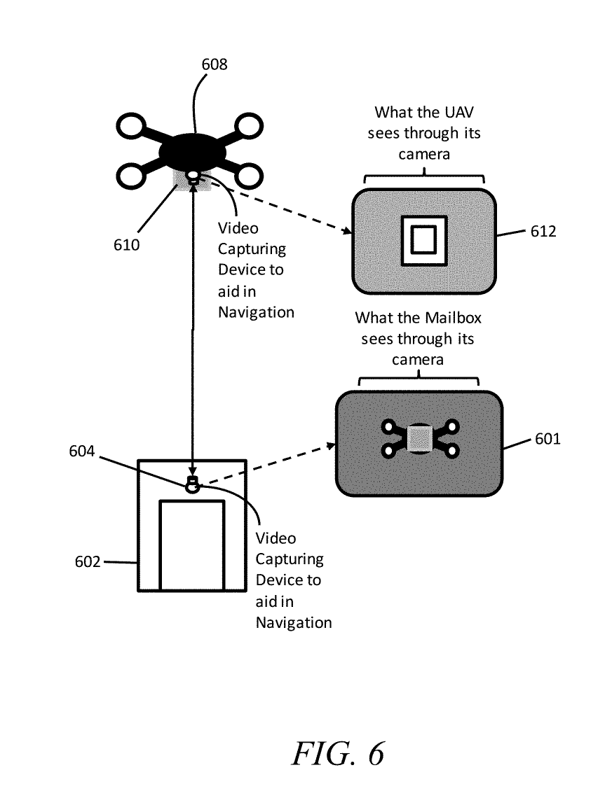

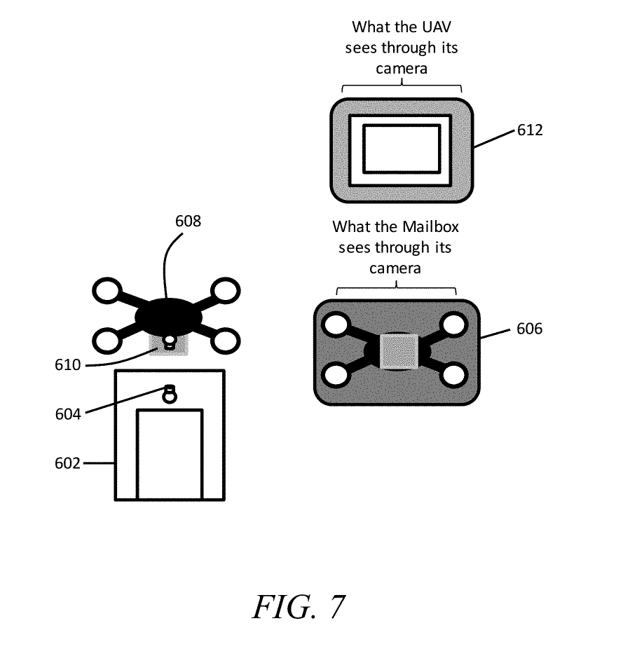

Referring now to FIG. 6 and FIG. 7, one example of a drone and an intelligent and secure storage unit with live video capabilities is described. The intelligent and secure storage unit 602 includes a camera 604 that obtains an image 606. The drone 608 includes a camera 610 that obtains an image 612. The images 606 and 612 may be part of live streaming images, which aid in the navigation of the drone 608 to and from the intelligent and secure storage unit 602. For example, the images may be used by the drone to make navigational adjustments and course corrections. The images in FIG. 6, represent a deployment situation where the drone 608 is relatively far from the intelligent and secure storage unit 602. The images of FIG. 7 represent the deployment situation where the drone 608 is relatively close to the intelligent and secure storage unit 602.

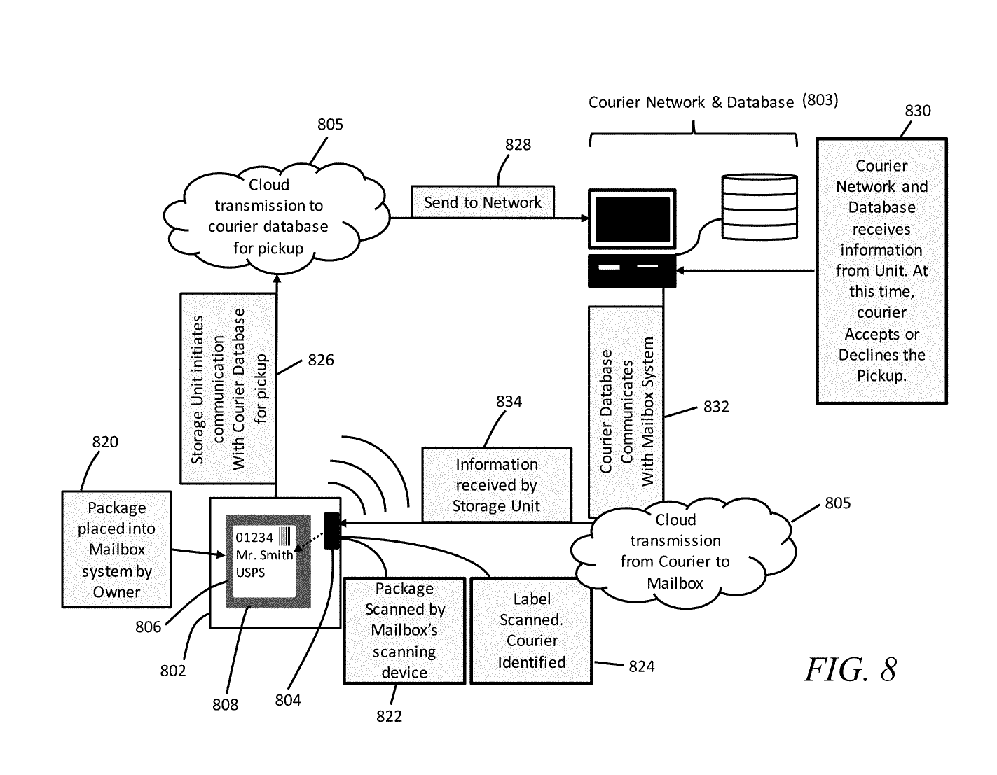

Referring now to FIG. 8, an intelligent and secure storage unit that is accessed by a human is described. A storage unit 802 has a scanner 804. A package 806 with a label 808 is placed into the unit 802 by a human owner of the unit 802 at step 820. At step 822, the label 808 is scanned by the scanner 804. At step 826, the unit 802 initiates communications with a courier network or data base 803 for pickup of the package 806 by sending a message to a cloud network 805 (or some other network).

At step 828, the message is sent to courier network and database 803. At step 830, the courier network and database 803 accepts or declines the pickup. Whether the pickup is accepted may depend upon the date and time of the pickup, the schedule of the courier, or whether the courier has the resources to make the pick-up. At step 832, the courier network and database 803 send a message through cloud 805 (which is shown twice in FIG. 8 for purposes of clarity) and at step 834 is received by unit 802.

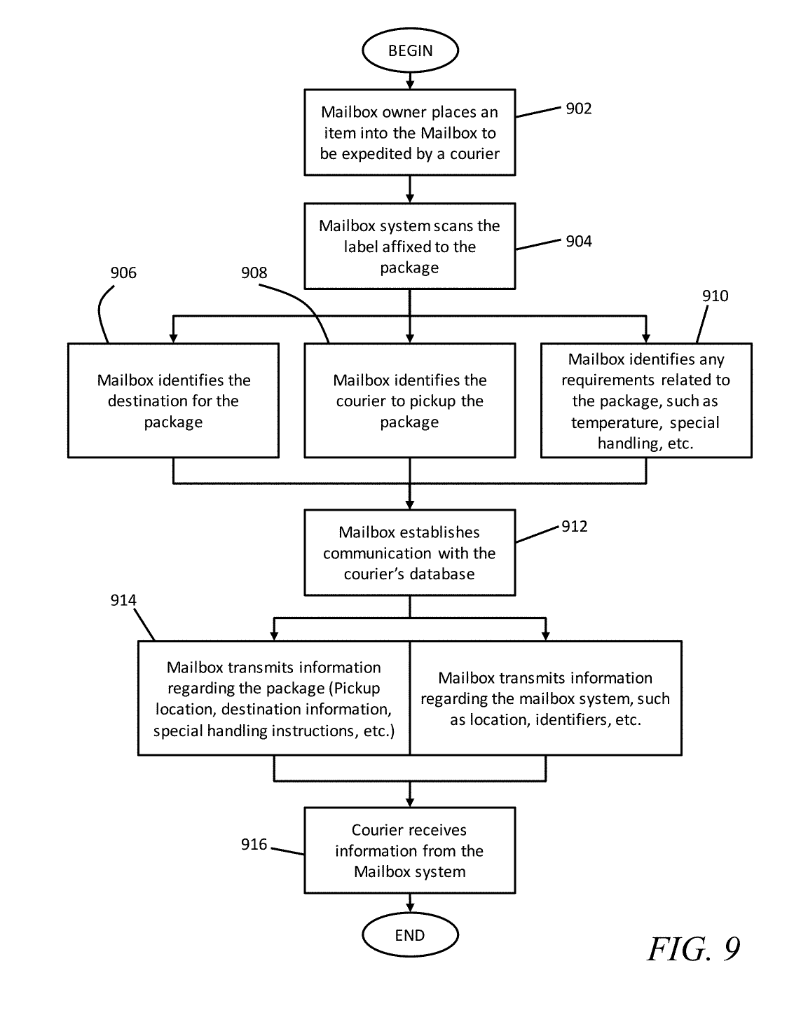

Referring now to FIG. 9, an example of a process for a human to return a package to a courier is described. At step 902, the owner of the storage unit places the item into the storage unit to be picked up by a courier. At step 904, the storage unit scans the label attached to the package.

Steps 906, 908, and 910 may be performed either serially or in parallel. At step 906, the unit identifies the destination for the package. At step 908, the unit identifies the courier for the package. At step 910, the unit identifies requirements relating to special handling for the package (e.g., temperature). The information concerning destination, courier and special requirements is included in the scanned information from the label.

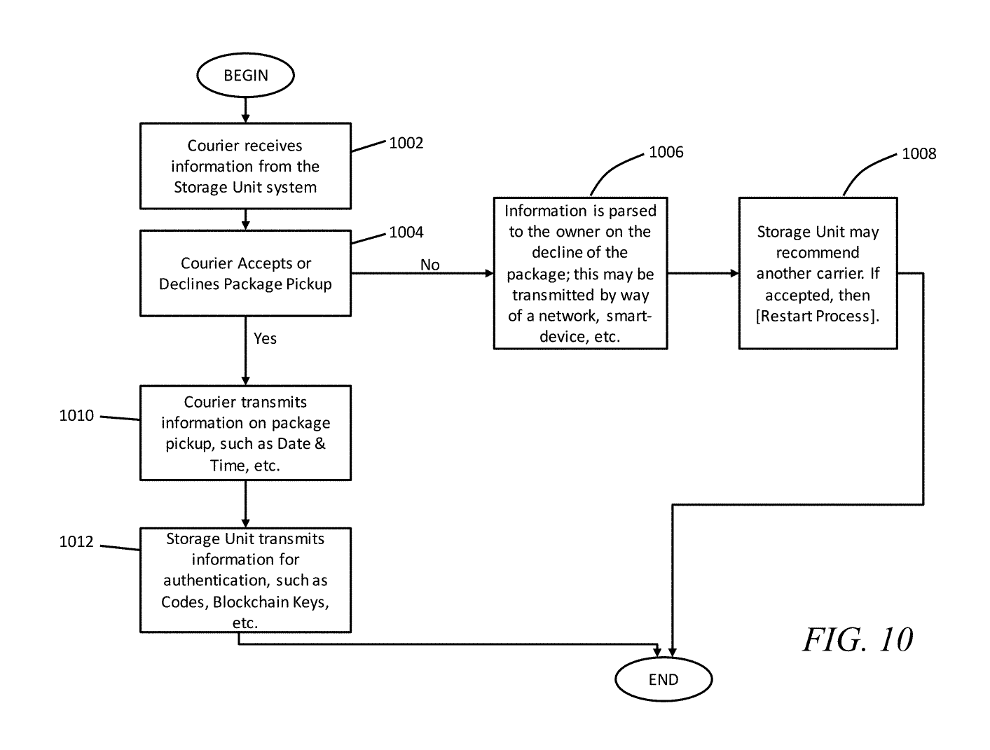

At step 912, the unit establishes communications with the network and database of the courier. At step 914, the unit transmits the information concerning the package to the courier network and database. The unit may also transmit information concerning itself such as the location of the unit. At step 916, the courier receives the information from the unit. The process may continue as shown in FIG. 10.

Referring now to FIG. 10 a process for a human for returning a package to a courier is further described. At step 1002, the courier receives the information transmitted from the unit (e.g., transmitted at step 916 of FIG. 9). At step 1004, the courier either accepts or declines the package. Whether the pickup is accepted by the courier may depend upon the date and time of the pickup, the schedule of the courier, or whether the courier has the resources to make the pick-up. If not accepted (answer is negative), at step 1006 information is sent to the owner concerning the decline of the package. For example, the information may include the reason why the pickup was declined. This information concerning the decision may be transmitted and presented to the owner in a number of different ways such as via a smart device). At step 1008, the storage unit may recommend another carrier. Other steps may also be taken. Execution then ends.

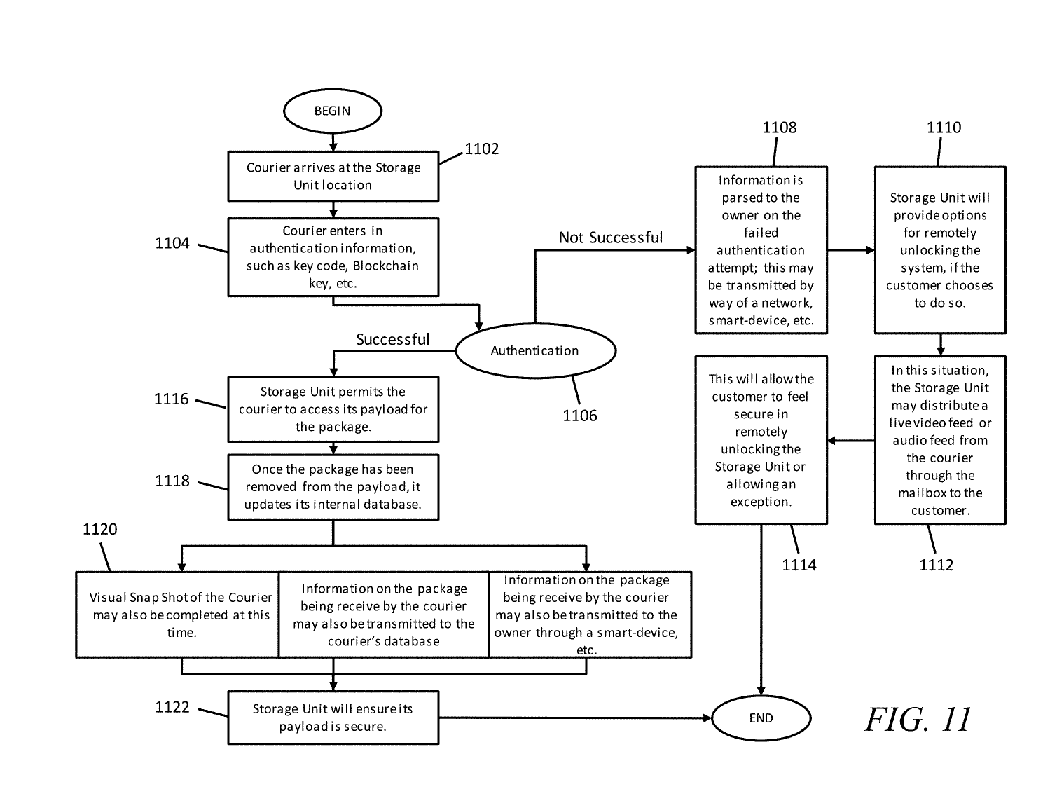

If the package is accepted (answer is affirmative), at step 1010 the courier transmits information on the package pickup (e.g., date and time) to the unit and/or the owner. The owner may use this information to prepare for package pickup (e.g., ensure the package is ready at the scheduled time). At step 1012, the unit transmits information to the courier for authentication (e.g., codes, blockchain keys). Authentication allows the package owner to know the pickup is a legitimate pickup. Execution then ends. The process may continue as shown in FIG. 11.

Referring now to FIG. 11, a process for a human for returning a package is described. At step 1102, the courier arrives at the location of the storage unit. At step 1104, the courier enters or supplies authentication information (e.g., key code, blockchain key) to the storage unit. At step 1106 authentication by the storage unit occurs. In aspects, the authentication information may be supplied by the storage unit to the courier before delivery occurs.

If authentication is not successful, at step 1108 information concerning the failure is determined and sent to the owner as to why the authentication failed. For example, the information may indicate that the courier supplied an incorrect password. Other examples are possible. At step 1110, the storage unit optionally provides options for remotely unlocking the unit if the customer wishes to do so. At step 1112, the storage unit may distribute a live video feed or audio feed from the courier through the unit to the customer. The live video feed shows live streaming video images as to what the courier is seeing and may aid the customer in making access (or other) determinations. At step 1114, the customer remotely unlocks the unit or allows the pickup to proceed despite the authentication failure.

If authentication is successful, at step 1116, the storage unit permits the courier to access its payload. At step 1118, once the package is removed, the internal database of the unit is updated.

At step 1120, a visual image of the courier may be made. Information concerning the package may be transmitted to and received by the courier. At step 1122, the storage unit ensures its compartments are secure. For example, the storage unit may verify that its doors are locked. Other examples are possible.

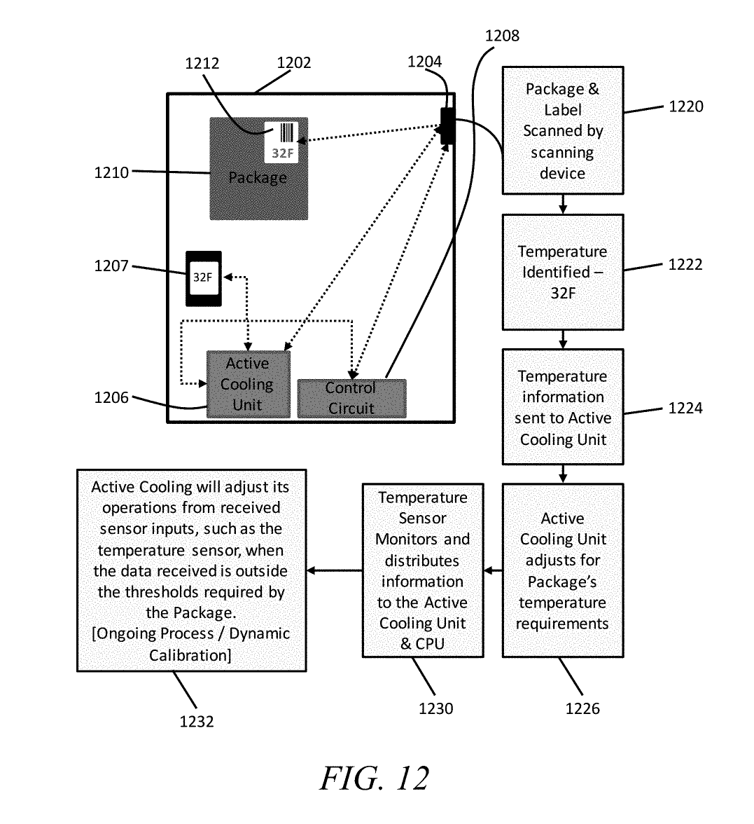

Referring now to FIG. 12, an intelligent and secure storage unit 1202 that controls environmental conditions within a unit is described. The unit 1202 includes a scanner 1204, an active cooling unit 1206, and a control circuit (e.g., CPU and data repository) 1208. A package 1210 (with a label 1212) is placed in the unit 1202.

At step 1220, the label 1212 of the package is scanned by the scanner 1204. The scanned information indicates the ideal temperature for the package 1210, in this case 32 degrees Fahrenheit.

At step 1224, this temperature information is sent to the active cooling unit 1206. At step 1226, the active cooling unit 1206 adjusts its temperature to match the required temperature. At step 1230, a temperature sensor 1207 monitors the temperature and sends the monitored temperature reading to the cooling unit 1206 to allow the cooling unit 1206 to fine-tune its operation to meet the 32 degree Fahrenheit requirement. At step 1232, the active cooling unit adjusts its operation as needed to meet the 32 degree Fahrenheit requirement. The control circuit 1208 may process information from the sensor and scanner and control the operation of the active cooling unit 1206.

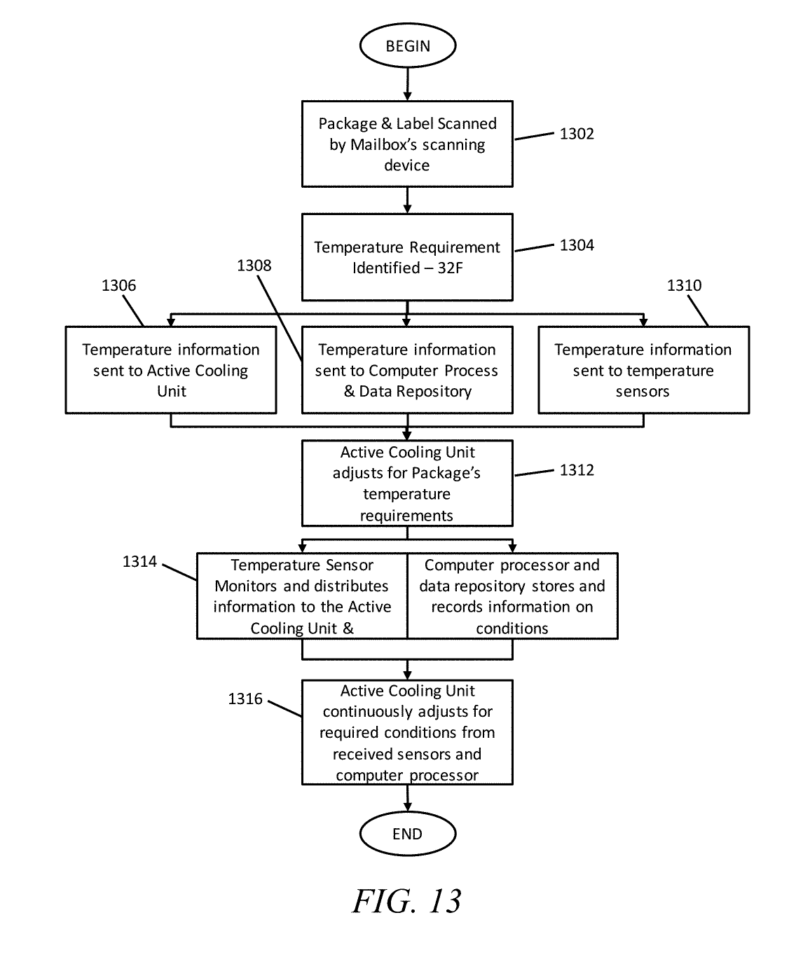

Referring now to FIG. 13, an approach for the intelligent and secure storage unit to control environmental conditions is described. A control circuit may control the operation of the active cooling unit. At step 1302, the label of a package is scanned by a scanning device at the storage unit. At step 1304, temperature information is identified in the scanned information. In this example, the package needs 32 degree Fahrenheit environment.

Steps 1306, 1308, and 1310 may be performed concurrently (or nearly concurrently). At step 1306, the temperature information is sent to the active cooling unit of the storage unit. At step 1308, the temperature information is sent to the control circuit (including a data repository) where the information may be stored. At step 1310, the storage information may be sent to temperature sensors in the storage unit where the package will be stored.

At step 1312, the active cooling unit adjusts the temperature in the storage chamber to meet the storage requirements of the package. At step 1314, the temperature sensor monitors the temperature in the chamber, and sends it to the control circuit, which actively controls the active cooling unit. At step 1316, the active cooling unit is continuously adjusted by the control circuit to maintain the temperature.

It will be appreciated that the example approach of FIG. 13 uses a device to cool a compartment. However, it will be appreciated that other parameters such as pressure may be controlled. Various compartments within the storage unit may have multiple parameters controlled. Consequently, each compartment can be configured individually to supply the required conditions to preserve a package and its contents.

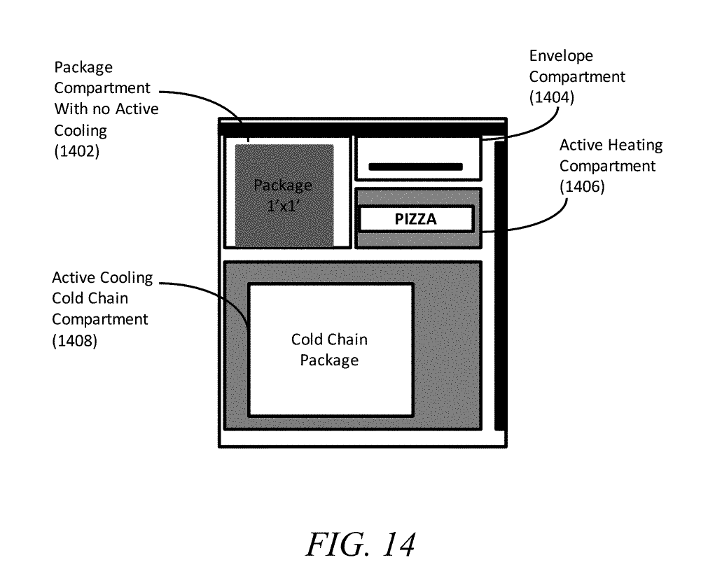

Referring now to FIG. 14, a storage unit with multiple compartments or chambers (each of which has environmental conditions individually controlled) is described. A first compartment 1402 (having dimensions of one foot by one foot by one foot) stores packages, and has no active cooling device (or any other environmental control device). A second compartment 1404 is an envelope compartment for storing envelopes (and has dimensions of 8 inches by 12 inches by 12 inches) and has no heating or cooling system. A third compartment 1406 (having dimensions of 9 inches by 12 inches by 12 inches) has a heating system for storing pizza. A fourth compartment 1408 (having dimensions of 2 feet by 2 feet by 2 feet) has an active cooling system for storage of packages requiring some form of refrigeration or cooling. It will be appreciated that the unit of FIG. 14 is one example, and that the given dimensions, the number of compartments, and the environmental control system deployed in each of the compartments may vary.

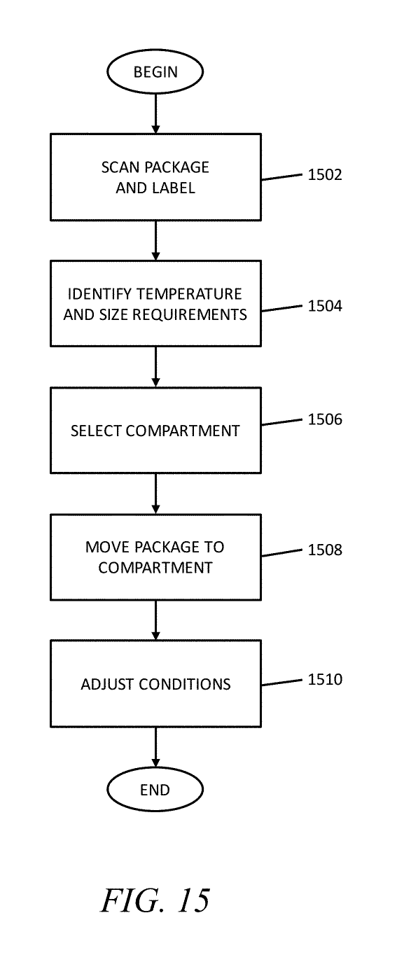

Referring now to FIG. 15, one example of operating a multiple compartment storage unit (such as the one of FIG. 14) is described. In this example, a payload receptor accepts packages and moves the packages between multiple compartments in the unit. A control circuit may select an appropriate compartment and then make adjustments to the compartment for specific requirements (e.g., temperature or size) of the package.

At step 1502, the label of a package is scanned by a scanning device at the storage unit. The scanning may include scanning a label on the package (e.g., to obtain temperature information) and scanning the package itself (to determine size information). At step 1504, temperature information and size information is identified in the scanned information. In this example, the package requires a 32 degree Fahrenheit environment to preserve its contents. The package also requires a compartment that is 2 feet by 2 feet.

At step 1506, an appropriate compartment is selected by the control circuit. For instance, the circuit can choose a compartment based upon size and whether the compartment has a cooling unit. Some (or all) compartments may be able to have their size adjusted (e.g., by moving partitions) and may have both heating and cooling units.

At step 1508, the package may be moved to the compartment. A payload receptor device such as a conveyor belt, elevator, or combinations of these and other devices may be used. At step 1510, the conditions are adjusted. For example, the control circuit may send a control signal to a cooling unit at the selected compartment to adjust the temperature to 32 degrees Fahrenheit. Partitions may be automatically or manually moved to meet the size or volume requirements of the package.

Once the package is in the compartment, the active cooling unit may be continuously adjusted to maintain the required conditions based upon sensor data. In these regards, sensors are deployed within compartments to sense parameters such as temperature.

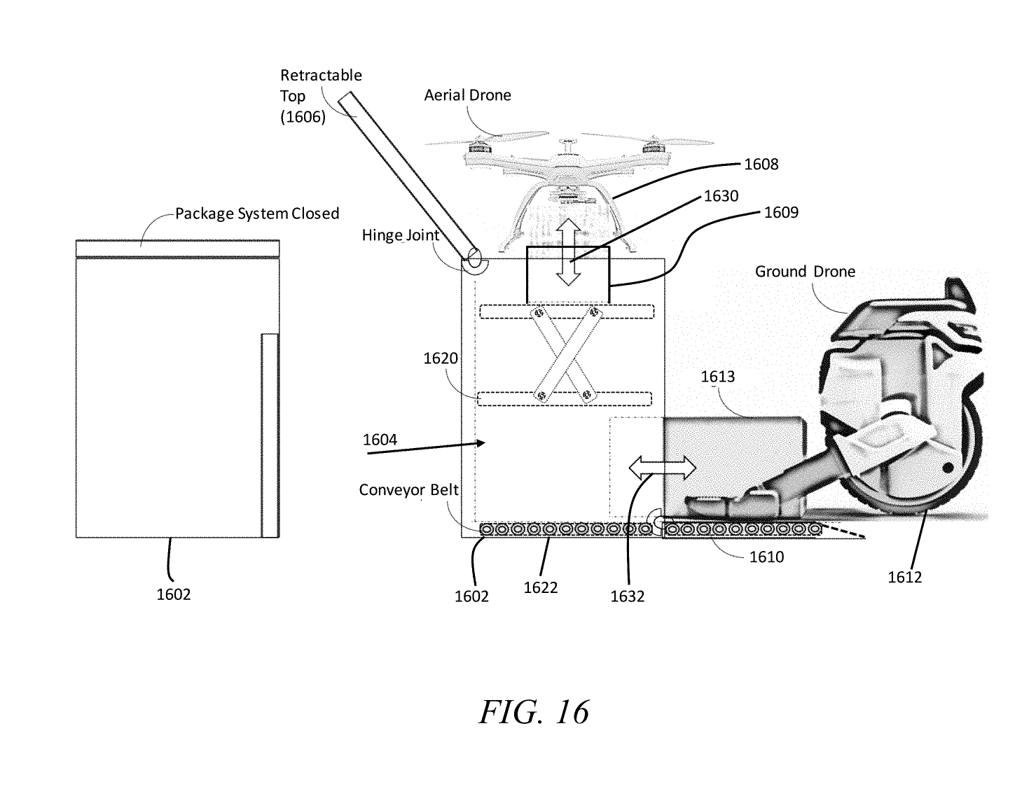

Referring now to FIG. 16, an intelligent and secure storage unit 1602 (with internal mechanical devices used to move packages within the unit 1602) is described. The intelligent and secure storage unit 1602 includes a compartment 1604 with a first door or top 1606 (allowing access by an aerial drone 1608 to deliver or retrieve a package 1609), and a retractable side door 1610 (allowing access by an autonomous ground vehicle 1612 to deliver or retrieve a package 1613).

The unit 1602 includes a retractable package retrieval apparatus 1620 that elevates and lowers packages to be accessed by the aerial drone 1608 in the direction indicated by the arrow 1630. A conveyor belt 1622 is used to move packages horizontal in the direction indicated by the arrow labeled 1632 so as to be accessible by the autonomous ground vehicle 1612.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. An intelligent and secure storage unit that receives and stores packages from couriers and facilitates the return of packages to the couriers, the intelligent and secure storage unit operating in a product delivery network and comprising:
a plurality of storage compartments;
an environmental control apparatus that is configured to individually control environmental conditions in each of the plurality of storage compartments;
a transceiver that communicates with an unmanned autonomous vehicle that is to deliver a package to or pick up the package from the intelligent and secure storage unit;
one or more position determination sensors, the one or more position determination sensors configured to obtain location information concerning an unmanned autonomous vehicle;
a control circuit coupled to the transceiver, the one or more position determination sensors, and the environmental control apparatus;
wherein the control circuit determines a current position of the unmanned autonomous vehicle using the sensed location information;
wherein the unmanned autonomous vehicle is self-guiding when disposed at locations beyond a predetermined distance from the intelligent and secure storage unit;
wherein the control circuit provides controlled guidance for the unmanned autonomous vehicle at locations within the predetermined distance using communications transmitted from the transceiver, the controlled guidance utilizing the current position of the unmanned autonomous vehicle;
wherein the control circuit assigns individual compartments according to an identity of the courier using the compartment, and whether the compartment will receive a package from a courier or return a package to the courier;
wherein when the unmanned autonomous vehicle deposits a package, the control circuit obtains environmental information concerning environmental conditions required by the package, and adjusts the environmental control apparatus of the selected compartment to provide the environmental conditions required by the package.

2. The intelligent and secure storage unit of claim 1, wherein the control circuit authenticates the identity of an unmanned autonomous vehicle, and grants permission for the unmanned autonomous vehicle to access the intelligent and secure storage unit.

3. The intelligent and secure storage unit of claim 2, wherein the unmanned autonomous vehicle is an aerial drone or a ground vehicle.

4. The intelligent and secure storage unit of claim 1, further comprising a scanner that scans packages for the environmental information, and wherein the control circuit is configured to analyze the scanned environmental information to determine the environmental conditions required by the package.

5. The intelligent and secure storage unit of claim 1, further comprising a user interface that is configured to receive authentication information from a human requesting that the human be allowed to access the intelligent and secure storage unit.

6. The intelligent and secure storage unit of claim 1, wherein the intelligent and secure storage unit communicates with devices inside a residence via the transceiver.

7. The intelligent and secure storage unit of claim 1, wherein the intelligent and secure storage unit communicates with the couriers via the transceiver.

8. The intelligent and secure storage unit of claim 1, wherein the intelligent and secure storage unit communicates with smart devices via the transceiver.

9. The intelligent and secure storage unit of claim 1, wherein the control circuit tracks packages received at and removed from the intelligent and secure storage unit.

10. A method of receiving and storing packages from couriers and facilitating the return of packages to the couriers, the method comprising:
individually controlling environmental conditions in each of a plurality of storage compartments in an intelligent and secure storage unit;
determining the location of an unmanned autonomous vehicle using sensors at the storage unit;
communicating with an unmanned autonomous vehicle, and directing and navigating the unmanned autonomous vehicle to and from the intelligent and secure storage unit according to the determined location and when the unmanned autonomous vehicle is within a predetermined distance of the unit;
assigning individual compartments according to an identity of the courier, and whether the compartment will receive a package from a courier or return a package to the courier;
wherein when the unmanned autonomous vehicle deposits a package, obtaining environmental information concerning environmental conditions required by the package, and adjusting the environmental control apparatus of the selected compartment to provide the environmental conditions required by the package.

11. The method of claim 10, wherein the directing and navigating comprises: authenticating the identity of the unmanned autonomous vehicle, and granting permission for the unmanned autonomous vehicle to access the intelligent and secure storage unit.

12. The method of claim 10, wherein obtaining environmental information comprises scanning the package for the environmental information, and analyzing the scanned environmental information to determine the environmental conditions required by the package.

13. The method of claim 10, wherein the unmanned autonomous vehicle is an aerial drone or a ground vehicle.

14. The method of claim 10, further comprising receiving authentication information at a user interface from a human requesting that the human be allowed to access the intelligent and secure storage unit.

15. The method of claim 10, further comprising communicating with devices inside a residence.

16. The method of claim 10, further comprising communicating with the couriers.

17. The method of claim 10, further comprising communicating with smart devices.

18. The method of claim 10, further comprising tracking packages received at and removed from the intelligent and secure storage unit.
